(19) United States
(12) Patent Application Publication
(10) Pub. No.: US 2026/0106765 A1
(43) Pub. Date: Apr. 16, 2026

(54) INFORMATION PROCESSING METHOD AND APPARATUS, COMMUNICATION DEVICE AND STORAGE MEDIUM

(71) Applicant: Beijing Xiaomi Mobile Software Co., Ltd., Beijing (CN)

(72) Inventor: Wei LU, Beijing (CN)

(73) Assignee: Beijing Xiaomi Mobile Software Co., Ltd., Beijing (CN)

(21) Appl. No.: 19/115,336

(22) PCT Filed: Sep. 28, 2022
(86) PCT No.: PCT/CN2022/122275

§ 371 Date: Mar. 26, 2025

(51) Int. Cl. H04L 9/32

(52) U.S. Cl. CPC H04L 9/3247; H04L 9/3263

(57) ABSTRACT

A system and method for securely transmitting and verifying system information in a non-terrestrial network (NTN) is disclosed. An NTN access network node digitally signs a system information block (SIB), which includes satellite coverage information, using a private key, and transmits the signed SIB to a terminal. The terminal verifies the digital signature using a corresponding public key to ensure the authenticity and integrity of the received SIB. The public key or a certificate containing the public key may be preconfigured in the terminal or provided by a core network device during an initial registration procedure. Based on the verification outcome, the terminal may adapt its state according to the satellite coverage information. The core network device facilitates the distribution of the public key or certificate to terminals supporting NTN access.

### CROSS-REFERENCE TO RELATED APPLICATIONS

This application is at the national stage of International Application No. PCT/CN2022/122275, filed on Sep. 28, 2022, which is hereby incorporated by reference in its entirety.

### TECHNICAL FIELD

The present disclosure relates to, but is not limited to, the field of wireless communication technologies, and in particular, to an information processing method and apparatus, a communication device, and a storage medium.

### BACKGROUND

To enhance 5th generation core (5GC) or evolved packet core network (EPC), non-terrestrial networks (NTN) are introduced. For example, the base station is carried on a satellite. However, an insufficient number of satellites in a starlink may lead to a scenario of discontinuous coverage.

Therefore, to reduce unnecessary power consumption of a terminal, when the terminal is about to leave a current network coverage, the network device triggers, by sending information such as satellite coverage information, the terminal to enter an idle state, to save power consumption generated when the terminal is maintained in a connected state. At the same time, while the terminal is triggered to enter the idle state, a power saving parameter is also sent to the terminal.

### SUMMARY

Embodiments of the present disclosure provide an information processing method and apparatus, a communication device and a storage medium.

A first aspect of the embodiments of the present disclosure provides an information processing method, performed by a non-terrestrial network (NTN) access network node, including:
digitally signing a system information block (SIB) by using a private key; and sending the SIB that is digitally signed.

A second aspect of the embodiments of the present disclosure provides an information processing method, performed by a terminal, including:
receiving a system information block (SIB) that is digitally signed by using a private key; and verifying a digital signature of the SIB by using a public key.

A third aspect of the embodiments of the present disclosure provides an information processing method, performed by a core network device, including:
sending a public key or a certificate including the public key of a non-terrestrial network (NTN)-radio access network (RAN) to a terminal, where the public key is used by the terminal to verify a digital signature of a system information block (SIB) sent by the NTN-RAN, where the digital signature is generated by the NTN-RAN by using a private key.

A fourth aspect of the embodiments of the present disclosure provides an information processing apparatus, including:
a signing module, configured to digitally sign a system information block (SIB) by using a private key; and
a first sending module, configured to send the SIB that is digitally signed.

A fifth aspect of the embodiments of the present disclosure provides an information processing apparatus, including:
a receiving module, configured to receive a system information block (SIB) that is digitally signed by using a private key; and
a verifying module, configured to verify a digital signature of the SIB by using a public key.

A sixth aspect of the embodiments of the present disclosure provides an information processing apparatus, including:
sending a public key or a certificate including the public key of a non-terrestrial network (NTN)-radio access network (RAN) to a terminal, where the public key is used by the terminal to verify a digital signature of a system information block (SIB) sent by the NTN-RAN, where the digital signature is generated by the NTN-RAN by using a private key.

A seventh aspect of the embodiments of the present disclosure provides a communication device, including a processor, a transceiver, a memory, and an executable program stored on the memory and executable by the processor, where the processor executes the executable program to implement the information processing method according to the first aspect, or the second aspect, or the third aspect.

An eighth aspect of the embodiments of the present disclosure provides a computer storage medium, storing an executable program; where when the executable program is executed by a processor, the method according to the first aspect, the second aspect, or the third aspect is implemented.

A ninth aspect of the embodiments of the present disclosure provides a communication system, including:
a non-terrestrial network (NTN) access node, configured to perform the information processing method according to any technical solution of the first aspect;
a terminal, configured to perform the information processing method according to any technical solution of the second aspect; and
a core network device, configured to perform the information processing method according to any technical solution of the third aspect.

According to the technical solution provided by the embodiment of the present disclosure, the SIB sent by the NTN access network node can be digitally signed by using the private key, so that situations of high terminal power consumption or unreachable terminal due to incorrect content carried by the SIB caused by illegal interception and/or tampering is reduced in the SIB transmission process, and the communication quality and the network use experience of the terminal are improved.

It should be understood that the above general description and the following detailed description are only examples and illustrative, and do not limit the embodiments of the present disclosure.

### BRIEF DESCRIPTION OF DRAWINGS

The accompanying drawings, which are incorporated in and constitute a part of this specification, illustrate embodiments consistent with the present disclosure and, together with the description, serve to describe the principles of the embodiments of the present disclosure.

FIG. 1 is a schematic structural diagram of a wireless communication system according to an example embodiment.

FIG. 2 is a schematic flow diagram of an information processing method according to an example embodiment.

FIG. 3 is a schematic flow diagram of an information processing method according to an example embodiment.

FIG. 4 is a schematic flow diagram of an information processing method according to an example embodiment.

FIG. 5 is a schematic flow diagram of an information processing method according to an example embodiment.

FIG. 6 is a schematic flow diagram of an information processing method according to an example embodiment.

FIG. 7 is a schematic flow diagram of an information processing method according to an example embodiment.

FIG. 8 is a schematic flow diagram of an information processing method according to an example embodiment.

FIG. 9 is a schematic structural diagram of an information processing apparatus according to an example embodiment.

FIG. 10 is a schematic structural diagram of an information processing apparatus according to an example embodiment.

FIG. 11 is a schematic structural diagram of an information processing apparatus according to an example embodiment.

FIG. 12 is a schematic structural diagram of a terminal according to an example embodiment.

FIG. 13 is a schematic structural diagram of a communication device according to an example embodiment.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the embodiments of the present disclosure. Rather, they are merely examples of apparatuses and methods consistent with some aspects of embodiments of the present disclosure.

The terminology used in the embodiments of the present disclosure is for the purpose of describing particular embodiments only and is not intended to limit the embodiments of the present disclosure. “One,” “said” and “this” of the singular forms used in the present disclosure are also intended to include plural forms unless the context clearly indicates other meanings. It should also be understood that the term “and/or” as used herein refers to and includes any or all possible combinations of one or more associated listed item.

It should be understood that although the terms “first,” “second,” “third,” etc., may be used to describe various information in the embodiments of the present disclosure, these information should not be limited to these terms. These terms are only used to distinguish a same type of information from each other. For example, without departing from the scope of the embodiments of the present disclosure, “first information” may also be referred to as “second information,” and similarly, “second information” may also be referred to as “first information”. Depending on context, the word “if” as used herein may be interpreted as “when” or “upon” or “in response to determining”.

FIG. 1 is a schematic structural diagram of a wireless communication system according to an embodiment of the present disclosure. As shown in the figure, a wireless communication system is a cellular mobile communication technology-based communication system, and the wireless communication system may include several terminals 11 and several access devices 12.

The terminal 11 may be a device that provides voice and/or data connectivity to a user. The terminal 11 may communicate with one or more core networks through a radio access network (RAN), and the terminal 11 may be Internet of Things terminal, such as a sensor device, a mobile phone (or referred to as a “cellular” phone), and a computer having the Internet of Things terminal, for example, may be a fixed, portable, pocket-sized, handheld, computer built-in, or in-vehicle apparatus. For example, a station (STA), a subscriber unit, a subscriber station, a mobile station, a mobile, a remote station, an access point, a remote terminal, an access terminal, a user terminal, a user agent, a user terminal, or a user equipment. Alternatively, the terminal 11 may be a device of an unmanned aerial vehicle. Alternatively, the terminal 11 may be an in-vehicle device, for example, may be a vehicle computer having a wireless communication function, or a wireless communication device externally connected to a vehicle computer. Alternatively, the terminal 11 may be a roadside device, for example, a street lamp, a signal light, or another roadside device having a wireless communication function.

The access device 12 may be a network side device in a wireless communication system. The wireless communication system may be a 4th generation mobile communication (4G) system, also referred to as a long term evolution (LTE) system; or the wireless communication system may be a 5G system, also referred to as a new radio system or a 5G NR system. Alternatively, the wireless communication system may be a next-generation system of a 5G system, or the like. The access network in the 5G system may be referred to as a new generation-radio access network (NG-RAN). Alternatively, the wireless communication system may be a machine type communication (MTC) system.

The access device 12 may be an evolved NodeB (eNB) used in a 4G system. Alternatively, the access device 12 may be an access device (gNB) in a centralized-distributed architecture in a 5G system. When the access device 12 uses a centralized-distributed architecture, the access network device 120 usually includes a central unit (CU) and at least two distributed units (DU). The centralized unit is provided with a protocol stack of a Packet Data Convergence Protocol (PDCP) layer, a Radio Link Control (RLC) layer, and a Media Access Control (MAC) layer; and the distributed unit is provided with a protocol stack of a Physical (PHY) layer, which is not limited in the embodiments of the present disclosure.

A wireless connection may be established between the access device 12 and the terminal 11 through a wireless air interface. In different implementations, the wireless air interface is a wireless air interface based on a fourth generation mobile communication network technology (4G) standard; or the wireless air interface is a wireless air interface based on a fifth generation mobile communication network technology (5G) standard, for example, the wireless air interface is a new air interface; or the wireless air interface may also be a wireless air interface based on a next generation mobile communication network technology standard of 5G.

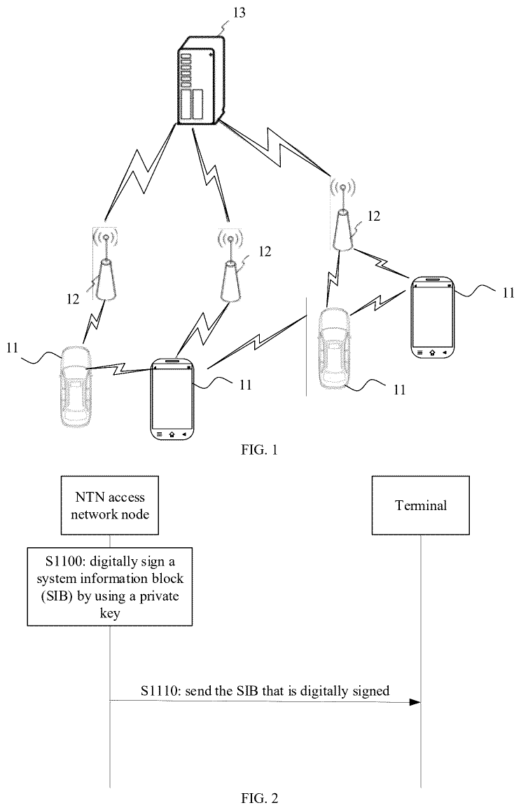

As shown in FIG. 2, an embodiment of the present disclosure provides an information processing method, performed by a non-terrestrial network (NTN) access network node, including:

S1100: digitally signing a system information block (SIB) by using a private key; and

S1110: sending the SIB that is digitally signed.

The NTN access network node may include, but is not limited to, an NTN base station. For example, the base station of the NTN may be carried by a satellite. The satellite may include a synchronous satellite, or a non-synchronous satellite such as a ground orbit satellite. The NTN access network node is a communication node (or referred to as a communication device) located in an NTN access network (Radio Access Network, RAN).

The SIB may be a master information block (MIB), or may be an SIBx, where x may be any positive integer. For example, x may be 1, 2, 3, 4, etc.

In the embodiment of the present disclosure, the SIB is a SIB digitally signed by using a private key of the NTN access network node. For example, at least some content in the SIB is digitally signed using the private key, and of course, it is also possible that all SIB content is digitally signed using the private key.

It should be understood that the private key and the public key are an asymmetric key pair.

In an embodiment, multiple NTN access network nodes of an NTN may share the same key pair. In another embodiment, multiple NTN access network nodes of an NTN may use different key pairs. For example, multiple NTN access network nodes within a same tracking area or routing area may share the same key pair, while multiple NTN access network nodes within different tracking areas or routing areas may use different key pairs.

In another embodiment, each NTN access network node has a corresponding key pair, that is, key pairs of different NTN access networks are independent of each other.

For example, the SIB may include one or more pieces of information, and the private key may be used to sign the one or more pieces of information in the SIB. In this way, data integrity protection can be performed on information in the SIB, thereby reducing tampering by an illegal node with an important message in the SIB, and ensuring correctness of the received SIB by the terminal.

In some embodiments, the SIB includes satellite coverage information of the NTN access network node.

The satellite coverage information may be used by the terminal to determine a time period with NTN signal coverage in a specified area and/or a time period without NTN signal coverage in the specified area.

For example, the satellite coverage information may include:
area information, where the area information may indicate a location covered by an NTN signal and/or a location not covered by the NTN signal;
time information, where the time information may indicate a time period with the NTN signal coverage and/or a time period without the NTN signal coverage.

In the embodiment of the present disclosure, the terminal located in the specified area determines whether to enter an idle state or an inactive state that saves power consumption according to the NTN signal coverage condition of the specified area. In the idle state or the inactive state, the terminal may not frequently monitor the message sent by the network device, thereby reducing unnecessary overheads. The idle state may include: a connected management (CM) idle state.

In an embodiment, when sending the SIB, the NTN further sends, to the terminal, first signature information generated by digitally signing the SIB by using the private key. In this way, the terminal receives the first signature information as well as receiving the SIB.

For example, the SIB is broadcast. The terminal receives the SIB and the first signature information of the SIB on the broadcast channel. The first signature information may be used by the terminal to verify the digital signature of the SIB.

In the embodiment of the present disclosure, if the satellite coverage information is included in the SIB signed by using the private key, and if the satellite coverage information is tampered, the terminal may verify the digital signature by using the public key corresponding to the private key after receiving the satellite coverage information, to determine whether the satellite coverage information is tampered, and if the satellite coverage information is tampered, the SIB may be discarded, thereby reducing an access attempt and/or signal monitoring of the terminal without NTN signal coverage caused by the tampered satellite coverage information, thereby reducing unnecessary overheads; or avoiding a communication interruption of the terminal caused by no attempt to access a network or no signal monitoring when NTN signal coverage exists.

In some embodiments, digitally signing the SIB by using the private key includes at least one of:
digitally signing all information of the SIB by using the private key; or,
digitally signing the satellite coverage information of the SIB by using the private key.

For example, if all information in the SIB is signed by using the private key, a digital signature generated by signing all information in the SIB may be used to perform signature protection on all information carried in the SIB.

Certainly, in another embodiment, whether the entire SIB is digitally signed or part of information in the SIB is digitally signed may be determined based on a security level or a system performance requirement of information included in the SIB.

In conclusion, in the embodiment of the present disclosure, if the SIB carries the satellite coverage information, at least the satellite coverage information carried in the SIB is signed by using the private key, to ensure integrity of the satellite coverage information received and used by the terminal.

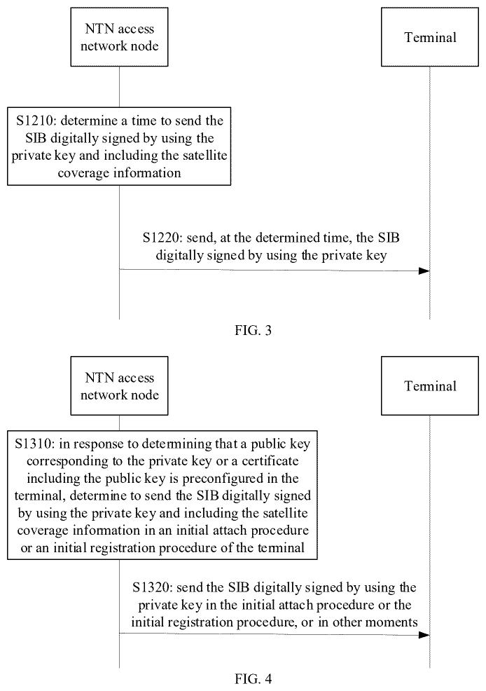

As shown in FIG. 3, an embodiment of the present disclosure provides an information processing method, performed by a non-terrestrial network (NTN) access network node, including:
S1210: determining a time to send the SIB digitally signed by using the private key and including the satellite coverage information.
S1220: sending, at the determined time, the SIB digitally signed by using the private key.

For example, S1210 may include:
determining, according to a manner of obtaining a public key corresponding to the private key by the terminal, the time to send the SIB digitally signed by using the private key and including the satellite coverage information;
   or,
determining, according to configuration information of the NTN access network node, the time to send the SIB digitally signed by using the private key and including the satellite coverage information.

For example, when the public key of the terminal is preconfigured in the terminal, the SIB signed by using the private key and including the satellite coverage information may be sent to the terminal in an initial registration stage (or procedure) of the terminal. For another example, when the terminal obtains the public key from the NTN access network node or a core network node after registration, the SIB signed by using the private key and including the satellite coverage information may be sent to the terminal after the terminal finishes the initial registration and obtains the public key.

By determining a time to send the SIB signed by using the private key and including the satellite coverage information, and sending the SIB at an appropriate time, it can be ensured that after receiving the SIB, the terminal can perform digital signature verification on the SIB immediately.

Certainly, in some embodiments, the method may further include:
sending, at any time, the SIB signed by using the private key and including the satellite coverage information; and if the terminal does not obtain the public key corresponding to the private key yet, the SIB can be cached, and the public key corresponding to the private key is requested from the network device, and digital signature verification can be performed on the cached SIB after requesting the public key.

In conclusion, in the embodiment of the present disclosure, if the SIB is digitally signed by using the private key, the terminal performs digital signature verification on the SIB after obtaining the public key.

As shown in FIG. 4, an embodiment of the present disclosure provides an information processing method, performed by a non-terrestrial network (NTN) access network node, including:
S1310: in response to determining that a public key corresponding to the private key or a certificate including the public key is preconfigured in the terminal, determining to send the SIB digitally signed by using the private key and including the satellite coverage information in an initial attach procedure or an initial registration procedure of the terminal.
S1320: sending the SIB digitally signed by using the private key in the initial attach procedure or the initial registration procedure, or in other moments.

For example, the public key or the certificate may be written into the terminal in advance. For example, it is written into a subscriber identity module (SIM) included in the terminal. The SIM may be an embedded SIM, or may be a standalone SIM or a physical SIM that may be mounted within and removable from a card slot of the terminal.

In an embodiment, if multiple NTN access networks or all NTN access networks share a same key pair, the public key may be preconfigured in the terminal.

In another embodiment, if multiple NTN access networks share a same key pair, when the terminal accesses to the NTN not for the first time, the public key or the certificate including the public key may have been obtained through information exchange to the core network when accessing other NTN access networks.

As shown in FIG. 5, an embodiment of the present disclosure provides an information processing method, performed by a non-terrestrial network (NTN) access network node, including:
S1410: in response to determining that the terminal obtains a public key corresponding to the private key or a certificate of the public key from a core network device, determining to send the SIB digitally signed by using the private key and including the satellite coverage information after an initial registration of the terminal.
S1420: sending the SIB digitally signed by using the private key after the initial registration of the terminal.

The certificate may be used by the terminal to obtain a public key corresponding to the private key used by the NTN access network node.

For example, if the terminal requests the public key or the certificate from the core network device, a request identifier may be carried in an initial registration request message or an attach request message. In such way, the core network device may carry the public key or the certificate in an initial registration response message or an attach response message. The core network device may include but is not limited to an access management function (AMF).

In the embodiments shown in FIG. 4 and FIG. 5, depending on different manners for the terminal to obtain the public key, the NTN access network node may send the SIB signed by using the private key to the terminal at different time.

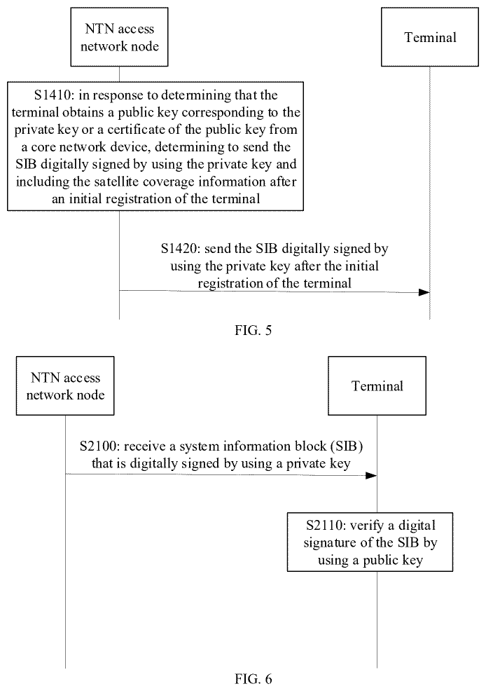

As shown in FIG. 6, an embodiment of the present disclosure provides an information processing method, performed by a terminal, including:
S2100: receiving a system information block (SIB) that is digitally signed by using a private key; and
S2110: verifying a digital signature of the SIB by using a public key.

The terminal may be any type of communication device.

For example, the terminal includes but is not limited to a mobile phone, a tablet computer, a wearable device, an in-vehicle device, a smart home device, or a smart office.

As the SIB sent by the NTN access network node is digitally signed by using the private key, therefore, upon receiving the SIB, the terminal performs data signature verification on the SIB by using a public key corresponding to the private key.

In an embodiment, the SIB may be any SIB that carries information (or a parameter) that needs to be received by the terminal. The SIB may include a MIB or a SIB.

The public key and the private key for digitally signing the SIB are an asymmetric key pair.

Since the SIB is digitally signed using the private key, the terminal performs digital signature verification on the SIB using the public key.

The terminal further receives first signature information when receiving the SIB.

The terminal performs digital signature decoding on the SIB by using the public key.

If the decoding succeeds, it may be determined that the SIB passes the signature verification.

In this way, a risk that the SIB is tampered can be reduced, and problems caused by tampered information content of the SIB can be reduced.

In some embodiments, verifying the digital signature of the SIB by using the public key includes: verifying the digital signature in the SIB including satellite coverage information by using the public key.

In some embodiments, not all SIBs need to be digitally signed by using the private key and use the public key to verify the digital signature of the SIB, but the digital signature of the SIB including the satellite coverage information will be verified, thereby reducing unnecessary signature verification of the SIB.

In some embodiments, the method includes:
in response to successfully verifying the digital signature, switching a state of the terminal according to satellite coverage information.

For example, after the SIB passes the digital signature verification, the state of the terminal is switched according to the satellite coverage information carried in the SIB, for example, the terminal is controlled to be switched from a CM-connected state to a CM-idle state, or the terminal is controlled to be switched from the CM-idle state to the CM-connected state according to the satellite coverage information.

Since the satellite coverage information is verified by the digital signature, it can be ensured that the state switching of the terminal refers to the unintercepted and untampered satellite coverage information, so that the state of the terminal and the NTN signal coverage condition remain consistent.

In some embodiments, the method further includes:
reading the public key or a certificate including the public key preconfigured in the terminal;
   or,
obtaining the public key or a certificate including the public key from a core network device.

In the embodiment of the present disclosure, when the public key or the certificate including the public key is pre-stored in the terminal, a processor of the terminal may read the public key or the certificate including the public key from a storage location such as a SIM of the terminal or a memory of the SIM, so that the processor of the terminal obtains the public key for performing data signature verification on the received SIB.

In another embodiment, when the terminal does not preconfigure the public key or the certificate including the public key, the terminal may obtain the public key or the certificate including the public key from the core network device.

For example, the core network device may be a core network device such as an AMF, a PCF (policy control function), or user data management (UDM) of the terminal.

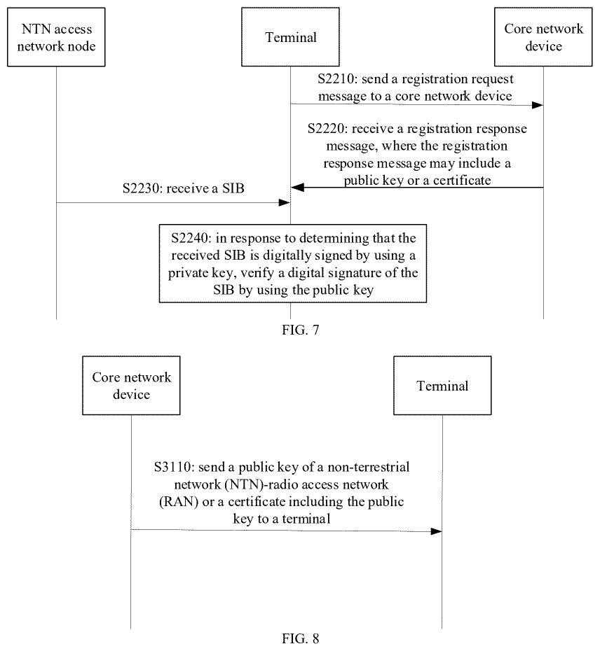

As shown in FIG. 7, an embodiment of the present disclosure provides an information processing method, performed by a terminal, including:
S2210: sending a registration request message to a core network device;
S2220: receiving a registration response message, where the registration response message may include a public key or a certificate;
S2230: receiving a SIB;
S2240: in response to determining that the received SIB is digitally signed by using a private key, verifying a digital signature of the SIB by using the public key.

The registration response message may include a registration accept message or a registration reject message. The public key or the certificate may be carried in the registration accept message.

For example, the registration request message may include: an initial registration request message, or a registration request message triggered to be sent due to periodic update, tracking area update (TAU), or routing area update (RAU).

In an embodiment, the registration request message may add an information element (IE), use remaining bits of the registration request message, to request the public key or the certificate from the core network device. In this way, after receiving the registration request message, the core network device receives the registration response message, which includes the public key or the certificate.

In another embodiment, the core network device discovers that the registration request message of the terminal is transmitted to the core network device through the NTN access network that will sign the SIB by using the private key, and in this case, even if the registration request message does not carry the indication to request the public key or the certificate, the core network device returns a registration response message including the certificate or the public key to the terminal.

The terminal obtains the public key or the certificate including the public key based on the registration response message.

In this way, when the received SIB is signed by using the private key, data signature verification is performed on the SIB by using the public key; otherwise, information content included in the SIB may be directly read.

In some embodiments, obtaining the public key or the certificate including the public key from the core network device includes:
receiving the public key or the certificate including the public key sent by the core network device in an initial registration procedure of the terminal.

For example, upon powering on, the terminal will attempt to access the network, and the terminal will initiate an initial registration procedure. In the initial registration procedure, the terminal sends an initial registration request message to the core network device, and receives an initial registration response message returned by the core network based on the initial registration request message. If the terminal successfully registers with the network, the terminal receives a registration accept message, which may include the public key or the certificate, including the public key.

In some other embodiments, the public key or the certificate including the public key is not limited to be included in the registration response message, and may also be included in another message of the initial registration process, for example, may be included in a dedicated message for sending the public key or the certificate in the initial registration process.

In conclusion, there are multiple ways in which the terminal obtains the public key or the certificate from the core network device, and specific implementation is not limited to the above examples.

According to an embodiment of the present disclosure, an information processing method is provided, performed by a terminal, including:
sending capability information of the terminal to a core network device, where the capability information may be used by the core network device to determine whether the terminal supports access to an NTN; and
if the terminal supports access to the NTN, receiving a public key of the NTN-RAN or a certificate including the public key. The public key may be used to perform digital signature verification on the SIB sent by the NTN-RAN.

As shown in FIG. 8, an embodiment of the present disclosure provides an information processing method, performed by a core network device, including:
S3110: sending a public key or a certificate including the public key of a non-terrestrial network (NTN)-radio access network (RAN) to a terminal, where the public key is used by the terminal to verify a digital signature of a system information block (SIB) sent by the NTN-RAN, where the digital signature is generated by the NTN-RAN by using a private key.

The core network device includes but is not limited to an AMF.

The public key in the key pair for digitally signing the SIB by the NTN access network node is preconfigured in the core network device.

For example, the core network device may receive the public key of the NTN access network node from the network management device in advance.

For another example, the core network device may receive the public key of the NTN-RAN from the NTN access network node.

After the public key is obtained, the public key of the NTN-RAN or the certificate including the public key is sent to the terminal, so that the terminal performs digital signature verification on the SIB of the NTN-RAN by using the public key subsequently.

For example, the public key or the certificate corresponding to the NTN-RAN is sent to the terminal according to the NTN-RAN through which the terminal registers to the core network; or the public key or the certificate to be sent is determined according to an NTN-RAN identifier carried in the NTN-RAN message accessed or requested by the terminal, and the public key or the certificate is sent to the terminal.

For another example, the request message sent by the terminal is transmitted to the core network device through the NTN-RAN, and the core network device may determine, based on the NTN-RAN from which the request message comes, the public key of the NTN-RAN that is requested by the terminal.

In some embodiments, sending the public key or the certificate for obtaining the public key of the NTN-RAN to the terminal includes:
sending the public key or the certificate including the public key of the NTN-RAN to the terminal in an initial access procedure of the terminal.

By sending the public key or the certificate of the NTN-RAN to the terminal in the initial registration procedure, the terminal can obtain the public key as soon as possible to perform digital signature verification on the received SIB.

In some embodiments, sending the public key of the NTN-RAN or the certificate including the public key to the terminal includes:
in response to determining that the terminal supports NTN access according to capability information of the terminal, sending the public key or the certificate including the public key of the NTN-RAN to the terminal.

It should be understood that the core network device may also initiatively send the public key of the NTN-RAN or the certificate including the public key to the terminal, or may send the public key of the NTN-RAN or the certificate including the public key to the terminal according to a request of the terminal. For example, in response to receiving a registration request message sent by the terminal, the core network device sends the public key of the NTN-RAN or the certificate including the public key to the terminal. This is not limited by the present disclosure.

When the terminal registers with the network through a terrestrial network (TN) access network or an NTN access network, the registration request message may carry terminal capability information, and the terminal capability information may indicate that the terminal has a capability of accessing the NTN. If the terminal has the capability of accessing the NTN, as the NTN access network signs the SIB by using the private key, the NTN access network sends the public key or the certificate to the terminal. If the terminal does not have the capability to access the NTN, the public key or the certificate does not need to be sent to the terminal.

An embodiment of the present disclosure provides an information processing method, including:
a terminal verifies authenticity and integrity of satellite coverage information included in a system information block (SIB) broadcast by a base station.

This solution assumes that each NTN-RAN has a key pair (private key and public key). The NTN-RAN generates a digital signature of the satellite coverage information by using the private key, and includes the satellite coverage information and the digital signature thereof in the SIB message and sends the SIB message to the terminal. The key pair includes a private key and a public key, the private key is used by the NTN access network node, and the public key is used by the terminal. The digital signature is one of the above first signature information.

When receiving the SIB message broadcast by the NTN access network node (NTN base station), the terminal verifies the digital signature of the satellite coverage information by using the certificate or public key of the NTN-RAN.

In a deployed NTN network, when there are a small number of NTN-RANs (for example, 1 to 3), a unified key pair may be configured for the NTN-RANs. In this case, a unified certificate or public key of the NTN-RANs may be preconfigured on the terminal, for example, when the NTN terminal user subscribes to the NTN service from the NTN operator, the certificate or public key is configured by using the universal subscriber identity module (USIM).

If the small number of NTN-RANs share a unified key pair, as the certificate or the public key is generally used within coverage of the NTN-RANs, the terminal may use the certificate or the public key preconfigured in subscription when moving between the small number of NTN-RANs.

Since the certificate is preconfigured in the terminal, the NTN-RANs may include the satellite coverage information in the SIB in the initial attach procedure.

In a deployed NTN network, if there are a large number of NTN-RANs, sharing a same key pair by the multiple NTN-RANs may cause security risk, and therefore, the multiple NTN-RANs are not configured with a unified key pair, and each NTN-RAN should have a respective key pair.

In this case, respective key pairs may be generated and distributed to the network (e.g., AMF) for different NTN-RANs based on an available public key infrastructure (PKI).

The AMF sends, to the terminal in an initial registration process, a list of certificates or public keys and a list of tracking area identity (TAI) of all NTN-RANs in coverage of the AMF.

When the terminal moves from one NTN-RAN to another NTN-RAN, the satellite coverage information broadcast by the current serving NTN-RAN may be verified by using a certificate or a public key corresponding to the current serving NTN-RAN. This also means that, only through a first-time registration, the terminal can obtain the certificate or public key of the NTN-RAN, and verify the digital signature of the satellite coverage information in the SIB. In this case, the NTN-RAN shall include the satellite coverage information in the SIB after the initial registration procedure.

For example, the terminal should be able to receive the certificate or public key of the NTN-RAN from the network in the initial registration process.

The terminal should be able to verify the digital signature of the satellite coverage information in the SIB by using at least the certificate or public key of the NTN-RAN.

The NTN-RAN should be able to digitally sign at least the satellite coverage information in the SIB message by using private key of the NTN-RAN itself.

The NTN-RAN should also be able to digitally sign the entire SIB message by using the private key of the NTN-RAN itself.

The NTN-RAN should be able to determine when to include satellite coverage information in the SIB message.

The AMF should be able to provide the terminal with the certificate or public key of the NTN-RAN within the NTN-RAN's coverage area in the initial registration procedure based on the capability of the terminal.

As shown in FIG. 9, an embodiment of the present disclosure provides an information processing apparatus, including:
a signing module 100, configured to digitally sign a system information block (SIB) by using a private key; and
a first sending module 110, configured to send the SIB that is digitally signed.

The information processing apparatus provided by the embodiment of the present disclosure may be the NTN access network node described above.

In an embodiment, the information processing apparatus may further include: a storage module, where the storage module may be connected to the first sending module 110, and may be configured to store the SIB signed by using the private key.

The signing module 100 may be a processing module, the processing module may correspond to a processor, and the processor may be a central processing unit, a digital signal processor, a microprocessor, or an embedded controller.

The first sending module 110 may correspond to a transceiver antenna.

In an embodiment, the SIB includes: satellite coverage information of the NTN access network node.

In an embodiment, the signing module is configured to perform at least one of:
digitally signing all information of the SIB by using the private key; or digitally signing the satellite coverage information in the SIB by using the private key.

In an embodiment, the apparatus further includes:
a determining module, configured to determine a time to send the SIB digitally signed by using the private key and including the satellite coverage information.

In an embodiment, the determining module is configured to: in response to determining that a public key corresponding to the private key or a certificate including the public key is preconfigured in a terminal, determining to send the SIB digitally signed by using the private key and including the satellite coverage information in an initial attach procedure or an initial registration procedure of the terminal; or, in response to determining that a terminal obtains a public key corresponding to the private key or a certificate of the public key from a core network device, determining to send the SIB digitally signed by using the private key and including the satellite coverage information after an initial registration of the terminal.

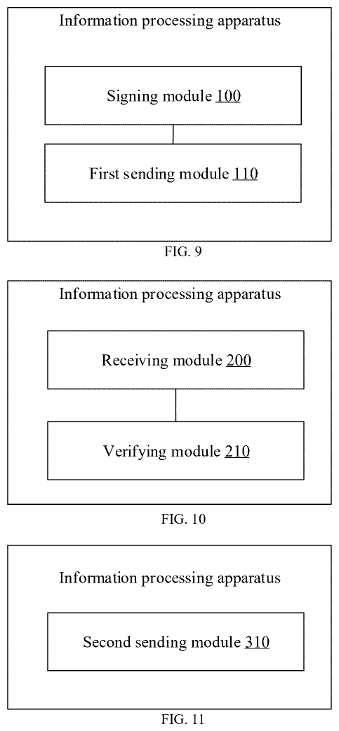

As shown in FIG. 10, an embodiment of the present disclosure provides an information processing apparatus, including:
a receiving module 200, configured to receive a system message block (SIB) that is digitally signed by using a private key; and a verifying module 210, configured to verify a digital signature of the SIB by using a public key.

The information processing apparatus may be a terminal.

In an embodiment, the receiving module 200 may correspond to a transceiver antenna of the terminal.

In an embodiment, the verifying module 210 may correspond to a processor. The processor includes, but is not limited to, a central processing unit, a microprocessor, or a digital signal processor.

In an embodiment, the information processing apparatus may further include a storage module connected to the verifying module 210 and configured to store the SIB.

In an embodiment, the verifying module 210 is configured to verify the digital signature of the SIB including satellite coverage information by using the public key.

In an embodiment, the apparatus includes:
a switching module, configured to: in response to successfully verifying the digital signature, switching a state of a terminal according to satellite coverage information.

In an embodiment, the apparatus further includes at least one of:
a reading module, configured to read the public key or a certificate including the public key preconfigured in a terminal; or,
an obtaining module, configured to obtain the public key or a certificate including the public key from a core network device.

In an embodiment, the obtaining module is configured to receive the public key or the certificate including the public key sent by the core network device in an initial registration procedure of the terminal.

As shown in FIG. 11, an embodiment of the present disclosure provides an information processing apparatus, including:
a second sending module 310, configured to send a public key or a certificate including the public key of a non-terrestrial network (NTN)-radio access network (RAN) to a terminal, where the public key is used by the terminal to verify a digital signature of a system information block (SIB) sent by the NTN-RAN, where the digital signature is generated by the NTN-RAN by using a private key.

The information processing apparatus may be a core network device.

The second sending module 310 may correspond to a transceiver antenna.

In an embodiment, the information processing apparatus may further include: a storage module, connected to the second sending module 310 and configured to store the public key or the certificate.

In another embodiment, the information processing apparatus may further include a processing module, where the processing module may include a processor that may be connected to the second sending module 310, and may be configured to verify the digital signature of the SIB by using a public key.

In an embodiment, the second sending module 310 is configured to send the public key of the NTN-RAN or the certificate including the public key to the terminal in an initial access procedure of the terminal.

In an embodiment, the second sending module 310 is configured to: in response to determining that the terminal supports NTN access according to capability information of the terminal, send the public key of the NTN-RAN or the certificate including the public key to the terminal.

An embodiment of the present disclosure provides a communication device, including:
a memory for storing a processor-executable instruction;
a processor connected to the memory;
where the processor is configured to perform the information processing method provided in any one of the above technical solutions.

The processor may include various types of storage media, the storage media are non-transitory computer storage media, and can continue to memorize information stored on the storage media after the communication device is powered off.

The communication device includes a terminal or a network element, and the network element may be any one of a first network element to a fourth network element.

The processor may be connected to the memory by using a bus or the like, and is configured to read an executable program stored in the memory, for example, at least one of the methods shown in FIG. 2 to FIG. 8.

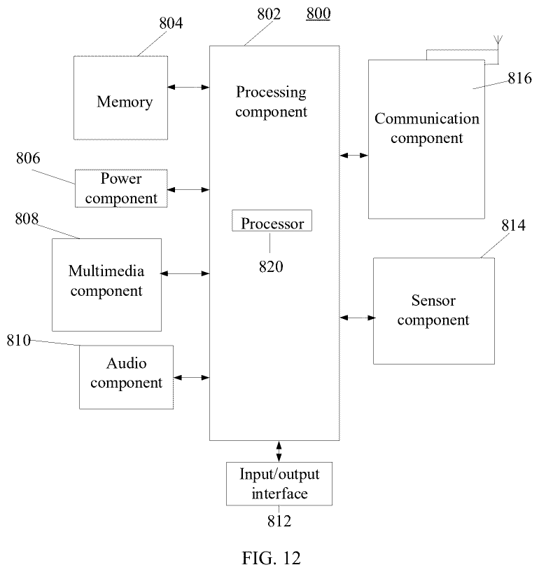

FIG. 12 is a block diagram of a terminal 800 according to an example embodiment. For example, the terminal 800 may be a mobile phone, a computer, a digital broadcast UE, a messaging device, a game console, a tablet device, a medical device, a fitness device, a personal digital assistant, or the like.

Referring to FIG. 12, the terminal 800 may include one or more of: a processing component 802, a memory 804, a power component 806, a multimedia component 808, an audio component 810, an input/output (I/O) interface 812, a sensor component 814, and a communication component 816.

The processing component 802 typically controls overall operations of the terminal 800, such as operations associated with display, telephone calls, data communications, camera operations, and recording operations. The processing component 802 may include one or more processors 820 to execute instructions to perform all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the terminal 800. Examples of such data include instructions for any application or method, contact data, phonebook data, messages, pictures, videos, etc., operating on the apparatus 1300. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 806 provides power for various components of the terminal 800. The power component 806 may include a power management system, one or more power sources, and other components associated with generating, managing, and distributing power for the terminal 800.

The multimedia component 808 includes a screen providing an output interface between the terminal 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 808 includes a front camera and/or a rear camera. When the terminal 800 is in an operation mode, such as a photographing mode or a video mode, the front camera and/or the rear camera may receive external multimedia data. Each of the front camera and the rear camera may be a fixed optical lens system or have focal length and optical zoom capability.

The audio component 810 is configured to output and/or input audio signals. For example, the audio component 810 includes a microphone (MIC) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and peripheral interface modules, which may be keyboards, click wheels, buttons, etc. These buttons may include, but are not limited to, home buttons, volume buttons, start buttons, and lock buttons.

The sensor component 814 includes one or more sensors for providing status assessments of various aspects of the terminal 800. For example, the sensor component 814 may detect an open/closed state of the terminal 800, relative positioning of components, such as a display and a keypad of the terminal 800, a change in position of the terminal 800 or a component of the terminal 800, a presence or absence of user contact with the terminal 800, an orientation or acceleration/deceleration of the terminal 800, and a change in temperature of the terminal 800. The sensor component 814 may include a proximity sensor configured to detect the presence of nearby objects without requiring any physical contact. The sensor component 814 may also include a light sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 may access a wireless network based on a communication standard, such as WiFi, 2G, 3G, 4G, 5G, or a combination thereof. In an example embodiment, the communication component 816 receives a broadcast signal or broadcast related information from an external broadcast management system via a broadcast channel. In an example embodiment, the communication component 816 further includes a near field communication (NFC) module to facilitate short-range communication. For example, NFC modules may be implemented based on radio frequency identification (RFID) technology, infrared data association (IrDA) technology, ultra-wideband (UWB) technology, Bluetooth (BT) technology, and other technologies.

In an example embodiment, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, and is configured to perform the above methods.

In an example embodiment, there is further provided a non-transitory computer-readable storage medium including an instruction, such as a memory 804 including the instruction, where the instruction is executable by a processor 820 of the terminal 800 to perform the above method. For example, the non-transitory computer-readable storage medium may be a ROM (read-only memory), a RAM (random access memory), CD-ROM (compact disc read-only memory), magnetic tape, floppy disk, optical data storage device, or the like.

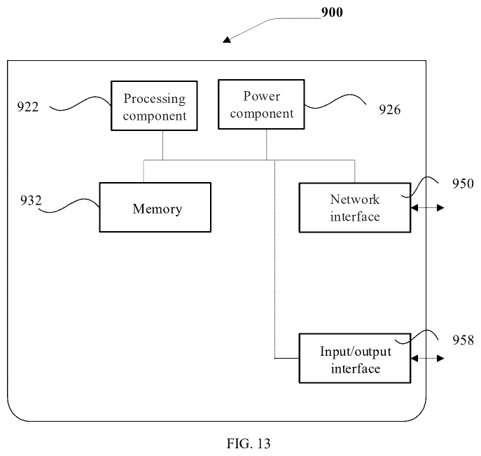

As shown in FIG. 13, an embodiment of the present disclosure shows a structure of a communication device. For example, the communication device 900 may be provided as a network-side device. The communication device may be the above NTN access network node and/or the core network device.

Referring to FIG. 13, the communication device 900 includes a processing component 922, which further includes one or more processors, and a memory resource represented by a memory 932 for storing instructions executable by the processing component 922, such as an application program. The application program stored in the memory 932 may include one or more modules each corresponding to a set of instructions. In addition, the processing component 922 is configured to execute instructions to perform any method applied to the access device in the above method, for example, the method shown in any one of FIG. 2 to FIG. 8.

The communication device 900 may also include a power component 926 configured to perform power management of the communication device 900, a wired or wireless network interface 950 configured to connect the communication device 900 to a network, and an input/output (I/O) interface 958. The communication device 900 may operate based on an operating system stored in memory 932, such as Windows Server ™, Mac OS X™, Unix ™, Linux ™, FreeBSD™, or the like.

The embodiments of the present disclosure provide a communication system, including:
an NTN access node, configured to perform any information processing method performed by the NTN access network node;
a terminal, configured to perform any information processing method performed by the terminal; and
a core network device, configured to perform any information processing method performed by the core network device.

An embodiment of the present disclosure provides a computer storage medium, where the computer storage medium stores an executable program; and when the executable program is executed by a processor, any one of the above information processing method executed by the NTN access network node, the terminal, and/or the core network device can be implemented.

Other embodiments of the present disclosure will easily occur to those skilled in the art after considering the specification and practicing the present disclosure herein. The present disclosure is intended to cover any variations, uses or adaptations of the present disclosure, which follow the general principles of the present disclosure and include common sense or common technical means in this technical field that are not disclosed in the present disclosure. The specification and examples are to be regarded as examples only, with the true scope and spirit of the present disclosure being indicated by the following claims.

It should be understood that the present disclosure is not limited to the precise structures described above and shown in the accompanying drawings, and various modifications and changes may be made without departing from the scope thereof. The scope of the present disclosure is limited only by the appended claims.

1. A method for information processing performed by a non-terrestrial network (NTN) access network node, the method comprising:
digitally signing a system information block (SIB) by using a private key; and
sending the SIB that is digitally signed.

2. The method according to claim 1, wherein the SIB comprises: satellite coverage information of the NTN access network node.

3. The method according to claim 2, wherein digitally signing the SIB by using the private key comprises at least one of:
digitally signing all information of the SIB by using the private key; or, digitally signing the satellite coverage information of the SIB by using the private key.

4. The method according to claim 2, wherein the method further comprises:
determining a time to send the SIB digitally signed by using the private key and comprising the satellite coverage information.

5. The method according to claim 4, wherein determining the time to send the SIB digitally signed by using the private key and comprising the satellite coverage information comprises at least one of:
in response to determining that a public key corresponding to the private key or a certificate comprising the public key is preconfigured in a terminal, determining to send the SIB digitally signed by using the private key and comprising the satellite coverage information in an initial attach procedure or an initial registration procedure of the terminal; or,
in response to determining that the terminal obtains a public key corresponding to the private key or a certificate of the public key from a core network device, determining to send the SIB digitally signed by using the private key and comprising the satellite coverage information after an initial registration of the terminal.

6. A method for information processing, performed by a terminal, the method comprising:
receiving a system information block (SIB) that is digitally signed by using a private key; and
verifying a digital signature of the SIB by using a public key.

7. The method according to claim 6, wherein verifying the digital signature of the SIB by using the public key comprises:
verifying the digital signature of the SIB comprising satellite coverage information by using the public key.

8. The method according to claim 6, wherein the method comprises:
in response to successfully verifying the digital signature, switching a state of the terminal according to satellite coverage information.

9. The method according to claim 6, wherein the method further comprises at least one of:
reading the public key or a certificate comprising the public key preconfigured in the terminal; or,
obtaining the public key or a certificate comprising the public key from a core network device.

10. The method according to claim 9, wherein obtaining the public key or the certificate comprising the public key from the core network device comprises:
receiving the public key or the certificate comprising the public key sent by the core network device in an initial registration procedure of the terminal.

11. A method for information processing, performed by a core network device, the method comprising:
sending a public key of a non-terrestrial network (NTN)-radio access network (RAN) or a certificate comprising the public key to a terminal, wherein the public key is used by the terminal to verify a digital signature of a system information block (SIB) sent by the NTN-RAN, wherein the digital signature is generated by the NTN-RAN by using a private key.

12. The method according to claim 11, wherein sending the public key of the NTN-RAN or the certificate comprising the public key to the terminal comprises:
sending the public key of the NTN-RAN or the certificate comprising the public key to the terminal in an initial access procedure of the terminal.

13. The method according to claim 11, wherein sending the public key of the NTN-RAN or the certificate comprising the public key to the terminal comprises:
in response to determining that the terminal supports NTN access according to capability information of the terminal, sending the public key of the NTN-RAN or the certificate comprising the public key to the terminal.

14-26. (canceled)

27. A communication device, comprising:
a transceiver,
a memory that stores executable program, and
one or more processors communicatively coupled to the transceiver and the memory,
wherein the executable program when collectively executed by the processors cause the communication device to act as the NTN access network node and perform the method according to claim 1.

28. A non-transitory computer storage medium, storing an executable program; wherein the executable program when executed by a processor of the NTN access network node, cause the NTN access network node to perform the method according to claim 1.

29. A communication system, wherein the communication system comprises:
a non-terrestrial network (NTN) access node, configured to perform the method according to claim 1.

30. A communication device, comprising:
a transceiver,
a memory that stores an executable program, and
one or more processors communicatively coupled to the transceiver and the memory, wherein the executable program when collectively executed by the one or more processors cause the communication device to act as the terminal and perform the method according to claim 6.

31. A communication device, comprising:
a transceiver,
a memory that stores an executable program, and
one or more processors communicatively coupled to the transceiver and the memory,
wherein the executable program when collectively executed by the one or more processors cause the communication device to act as the core network device and perform the method according to claim 11.

32. A non-transitory computer storage medium, storing an executable program; wherein the executable program when executed by a processor of the terminal, cause the terminal to perform the method according to claim 6.

33. A non-transitory computer storage medium, storing an executable program; wherein the executable program when executed by a processor of the core network device, cause the core network device to perform the method according to claim 11.
